(19) United States
(12) Patent Application Publication
(10) Pub. No.: US 2010/0101491 A1
(43) Pub. Date: Apr. 29, 2010

(54) WAFER LIFT PINS SUSPENDED AND SUPPORTED AT UNDERSIDE OF SUSCEPTOR

(75) Inventor: Koei Aida, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: ASM JAPAN K.K., Tokyo (JP)

(21) Appl. No.: 12/260,859

(22) Filed: Oct. 29, 2008

(51) Int. Cl. B05C 13/02

(52) U.S. Cl. 118/502

(57) ABSTRACT

A wafer lift pin structure for lifting a semiconductor wafer includes: a through-hole penetrating through a susceptor; an upper guide fixedly fitted inside the through-hole, a lift pin constituted by an upper part, a middle part, and a lower part and inserted in the upper guide; and a lower guide attached to the underside surface of the susceptor, wherein the lift pin is suspended from the lower guide at the middle part of the lift pin at the lower position. The middle part has a diameter greater than that of the upper part and that of the lower part, and has a weight heavier than that of the upper part and that of the lower part.

### BACKGROUND

1. Field of the Invention

The present invention generally relates to a susceptor for processing a semiconductor wafer, and particularly to a wafer lifting structure of the susceptor.

2. Description of the Related Art

In a reaction chamber, a semiconductor wafer is processed on a susceptor. When loading and unloading a wafer to and from the susceptor, the wafer is placed on lift pins over the susceptor. The lift pins are vertically movable through lift pin holes formed in the susceptor. When the wafer is processed, the lift pins are retracted within or through the susceptor, and when loading and unloading the wafer, the lift pins are extended upward for supporting the wafer thereon over the susceptor.

There are generally three types of lift pins known in the art.

FIGS. 1A and 1B are schematic cross sections showing first conventional lift pins and related structures. In this type, wafer lift pins 11 are fixed to a reaction chamber 13, and a susceptor (heater) 12 moves upward (FIG. 1B) and downward (FIG. 1A), so that the lift pins 11 are vertically extended and retracted relative to the top surface of the susceptor 12. This type of wafer lift pins 11 has the following problems: Due to the difference in thermal expansion coefficient between the reaction chamber 13 and the susceptor 12, it is difficult to adjust the setting of the lift pins 11. That is, the setting is conducted at room temperature whereas the lift pins are used at high temperatures. When the setting is not proper, the lift pins 11 may scratch an inner surface of the lift pin holes when the lift pins are vertically extended and retracted relative to the top surface of the susceptor 12, resulting in generation of particles. Further, when the susceptor 12 moves upward for processing the wafer, the tips of the lift pins may not be level with the top surface of the susceptor 12, affecting film deposition operation and cleaning operation. As a result, in order to avoid the above problems, it is required to adjust each lift pin individually, and thus it is difficult to use common lift pins or standardized lift pins.

FIGS. 2A and 2B are schematic cross sections showing a second type of conventional lift pins and related structures. This type of lift pins is shown in U.S. Pat. No. 5,421,893, for example. In this type, wafer lift pins 21 are suspended from the top of a susceptor 22. When the susceptor 22 is at a lower position (FIG. 2A), the bottoms of the lift pins 21 are placed on a surface of a reaction chamber 23, and the lift pins 21 are extended relative to the top surface of the susceptor 22. When the susceptor 22 moves upward (FIG. 2B), heads 24 of the lift pins 21 are caught by the top surface of the susceptor 22 and suspended therefrom. This type of lift pin has the following problems: When the susceptor moves upward (FIG. 2B), heads 24 of the lift pins 21 come in contact with a portion of the upper surface of the susceptor 22, shown in a shallow recess, resulting in generation of particles. Further, because the size of the heads 24 of the lift pins 21 is large, the area ratio of the heads 24 of the lift pins 21 to the area of the top surface of the susceptor 22 becomes high, affecting plasma discharge conditions and temperature distributions of a wafer.

FIGS. 3A and 3B are schematic cross sections showing a third type of conventional lift pins and related structures. This type of lift pins is shown in U.S. Pat. No. 6,190,113, for example. In this type, three wafer lift pins 31 are connected to each other by a connecting member 35 and operated as a single piece using a central shaft 34 of the susceptor 32. The lift pins 31 are not connected to a reaction chamber 33. In this type, the lift pins 31 can move upward and downward separately from the susceptor's movement. This type of lift pin system has the following problems: Because the lift pins 31 moves using the central shaft 34 of the susceptor 32, if the susceptor 32 is slightly deformed due to heat, the tips of the lift pins 31 may not be leveled with the top surface of the susceptor 32, affecting wafer handling. Further, because the lift pins are connected to each other, even a slight thermal deformation of the lift pins and the connecting member causes the lift pins to scratch inner surfaces of the holes, resulting in generation of particles.

### SUMMARY

Consequently, in an aspect, an object of the present invention is to provide a lift pin mechanisms which can solve one or more of the above problems.

An embodiment of the present invention provides a wafer lift pin structure for lifting a semiconductor wafer. The wafer lift pin structure includes (i) a through-hole penetrating vertically through a susceptor from an underside surface of the susceptor to an upper surface of the susceptor, wherein the through-hole is constituted by an upper through-hole and a lower through-hole which has an inner diameter larger than an inner diameter of the upper through-hole. The wafer lift pin structure also includes (ii) an upper guide having a through-hole in its axial direction aligned with an axis of the through-hole of the susceptor, the upper guide being fixedly fitted in the lower through-hole. The structure further includes (iii) a lift pin constituted by an upper part, a middle part, and a lower part, all of which have a common vertical axis aligned with the axis of the through-hole of the susceptor. The middle part has a diameter larger than that of the upper part, that of the lower part, and an inner diameter of the upper through-hole of the susceptor is larger than the diameter of the upper part. The middle part has a weight heavier than that of the upper part and that of the lower part of the lift pin. At least a portion of the middle part is slidably inserted inside the through-hole of the upper guide and axially movable between a lower position and an upper position, wherein an upper end of the upper part for supporting a wafer thereon is below the upper surface of the susceptor at the lower position, and the upper end of the upper part protrudes from the upper surface of the susceptor at the upper position. The structure further includes (iv) a lower guide attached to the underside surface and axially aligned with the through-hole of the susceptor, wherein the lower guide has a central opening through which the lower part of the lift pin is inserted and axially movable, the central opening having an diameter smaller than that of the middle part of the lift pin, wherein a lower end of the middle part is supported by the lower guide at the opening at the lower position.

In the above embodiment, because the lift pin is suspended at a point closer to the underside of the susceptor, the upper end of the upper part of the lift pin is not in contact with the upper surface of the susceptor and generation of particles from the upper end of the lift pin can be inhibited. Further, because the lift pin is not attached to a reaction chamber, even if the position of the susceptor relative to the reaction chamber deviates from the standard position (e.g., due to heat or the movement of the susceptor), the position of the lift pin relative to the upper surface of the susceptor is not changed. Furthermore, because the middle part of the lift pin has a diameter larger than that of the upper part and that of the lower part and has a weight heavier than that of the upper part and that of the lower part, stability and smoothness of the sliding of the lift pin upon the inner surface of the upper guide can significantly be improved. Accordingly, the movement of the lift pin can be significantly more stable and reliable as compared with the conventional lift pins. Further, in the embodiment, the setting of the lift pin is easy and does not require individual adjustment for each lift pin.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not to scale.

FIGS. 1A and 1B are schematic cross sections showing a first type of conventional lift pins and related structures.

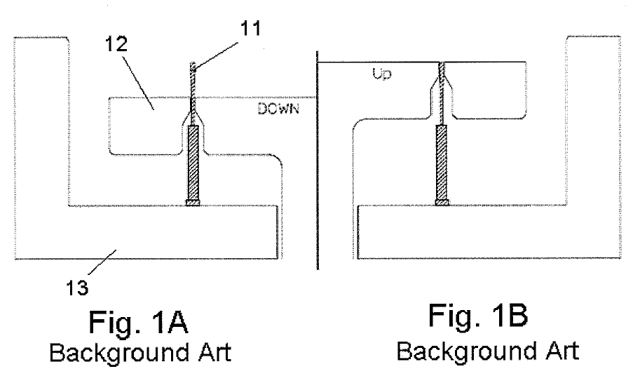

FIGS. 2A and 2B are schematic cross sections showing a second type of conventional lift pins and related structures.

FIGS. 3A and 3B are schematic cross sections showing a third type of conventional lift pins and related structures.

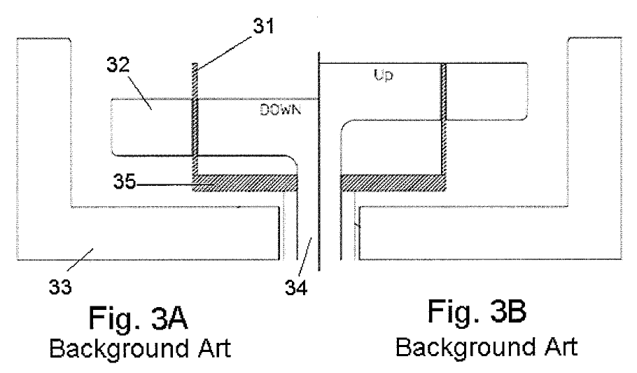

FIGS. 4A and 4B are schematic cross sections showing lift pins and related structures according to an embodiment of the present invention.

### DETAILED DESCRIPTION

As explained above, in an embodiment, the wafer lift pin structure for lifting a semiconductor wafer comprises: a through-hole penetrating through a susceptor; an upper guide fixedly fitted inside the through-hole; a lift pin constituted by an upper part, a middle part, and a lower part and inserted in the upper guide; and a lower guide attached to the underside surface of the susceptor, wherein the lift pin is suspended from the lower guide at the middle part of the lift pin at the lower position, wherein the middle part has a diameter greater than that of the upper part and that of the lower part, and has a weight heavier than that of the upper part and that of the lower part.

The disclosed embodiments include, but are not limited to, the following:

In an embodiment, the diameter of the middle part may be at least three times (preferably at least four times) the diameter of the upper part of the lift pin. In an embodiment, the length of the middle part may be at least 25% (preferably at least 30%) of the entire length of the lift pin. In an embodiment, the upper guide and the middle part of the lift pin may be made of different ceramics so as to improve slidability. Further, in an embodiment, the middle part of the lift pin may have a length greater than its diameter. At least in the above embodiments, stability and slidability of the lift pin can significantly be improved. Further, because the upper part of the lift pin can have a small diameter (because the upper part of the lift pin need not have a role in stabilizing the sliding of the lift pin), the diameter of the upper through-hole can be small, and thus influence upon plasma formation can be minimized.

In any of the foregoing embodiments, the lift pin may move down by gravity from the upper position to the lower position. In an embodiment, the lift pin may be suspended by gravity from the lower guide at the middle part of the lift pin at the lower position. The lift pin can move down by its own weight, but force other than gravity can be used, such as magnetic force or air pressure. In another embodiment, no force other than gravity is used for downward movement of the lift pin. Further, in an embodiment, no additional weight is attached to the lift pin.

In any of the foregoing embodiments, the upper part of the lift pin including the upper end thereof may have a circular cross section (preferably non-hollow) and may have a diameter smaller than that of the lower part of the lift pin. If the area of the upper end of the upper part of the lift pin is small, the lift pin does not convey heat to the wafer and/or the interior of the reaction chamber. Preferably, the lift pin has a circular cross section, but it can have a cross section other than a circle. For example, the cross section can be an oval, polygon such as square, etc. In that case, a diameter means a diameter of the smallest circle enclosing the cross section.

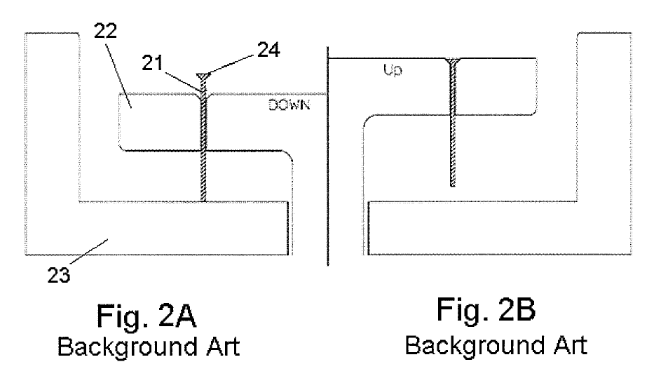

In any of the foregoing embodiments, the upper part of the lift pin may not be in contact with the upper surface of the susceptor at the lower position. By way of contrast, it can be seen in FIG. 2B that the pin head 24 contacts part of the susceptor upper surface within a recess. Preferably, the lift pin is suspended only from the lower guide, not from the upper surface of the susceptor, and because the lift pin does not contact the upper surface of the susceptor, generation of particles can effectively be inhibited. Contact is removed from the

In any of the foregoing embodiments, the lower guide may be hollow and cylindrical, have a bottom having the central opening, and have an annular rim attached to the underside surface of the susceptor. The lower guide can restrict the downward movement of the lift pin and can have any suitable shape. If the through-hole has a depth sufficient for the middle part of the lift pin to move up and down inside the through-hole, the lower guide can be shaped in a ring or disk with a central opening, which fits in the underside of the susceptor. In an embodiment, the lower guide can be attached to the underside of the susceptor by screws, press-fit, latching by rotation, threads, etc.

In any of the foregoing embodiments, the lower through-hole may have a depth greater than a length of the middle part of the lift pin. If the area of the inner surface of the lower through-hole which constantly contacts the middle part of the lift pin is great, the movement of the lift pin may be more stable along its axis and less subject to torque.

In any of the foregoing embodiments, a lower end of the lower part of the lift pin may be in contact with a surface of a reaction chamber or component thereof at the upper position. The lift pin moves up relative to the susceptor when the lower end of the lift pin is pushed upward. The upward movement of the lift pin can be accomplished by lowering the susceptor while the lower end of the lift pin contacts a bottom surface of the reaction chamber and its movement is restricted, for example. In an embodiment, a surface against which the lower end of the lift pin is pushed can be a surface which is not a part of the reaction chamber. The surface can be constituted by a plate which can be fixed to the reaction chamber or can be movable relative to the reaction chamber.

In any of the foregoing embodiments, the middle part of the lift pin and the lower part of the lift pin may be constituted by a single piece and may not be detachable without destruction, and the upper part of the lift pin may be detachable from the middle part of the lift pin without destruction. The lift pin can be a single piece which cannot be disassembled without destruction. Preferably, the upper part of the lift pin is attachable and detachable to and from the middle part of the lift pin without destruction, so that the upper part of the lift pin can be inserted from the upper of the susceptor whereas the middle and lower parts of the lift pin are inserted from the underside of the susceptor. As an example, the upper part of the lift pin can be externally threaded and the middle part of the lift pin can include an internally threaded bore for threadedly receiving the upper part of the lift pin. In an embodiment, the upper part of the lift pin is replaceable. The upper part of the lift pin may be exposed to excited process gas or cleaning gas and may be damaged. In that case, the upper part of the lift pin can be replaced without replacing the middle and lower parts of the lift pin.

In any of the foregoing embodiments, the underside of the susceptor may be provided with a ring, and the annular rim of the lower guide has a flange fitted in the ring. In an embodiment, the ring may be integrally formed with the susceptor without seams.

In another aspect, an embodiment provides a susceptor for supporting a semiconductor wafer thereon. The susceptor includes (i) multiple through-holes, each through-hole penetrating vertically through the susceptor from an underside surface of the susceptor to an upper surface of the susceptor, wherein each through-hole is constituted by an upper through-hole and a lower through-hole which has an inner diameter larger than an inner diameter of the upper through-hole. The susceptor also includes (ii) upper guides corresponding to the respective through-holes of the susceptor, each upper guide having a through-hole in its axial direction aligned with an axis of the through-hole of the susceptor, the upper guide being fixedly fitted in the lower through-hole. The susceptor also includes (iii) multiple lift pins corresponding to the respective through-holes, each lift pin constituted by an upper part, a middle part, and a lower part, all of which have a common vertical axis aligned with the axis of the through-hole of the susceptor. The middle part has a diameter larger than that of the upper part, that of the lower part, and an inner diameter of the upper through-hole of the susceptor, which is also larger than the diameter of the upper part, and the middle part has a weight heavier than that of the upper part and that of the lower part. At least a portion of the middle part is slidably inserted inside the through-hole of the upper guide and axially movable between a lower position and an upper position, wherein an upper end of the upper part for supporting a wafer thereon is below the upper surface of the susceptor at the lower position, and the upper end of the upper part protrudes from the upper surface of the susceptor at the upper position. The susceptor also includes (iv) multiple lower guides corresponding to the respective through-holes, Each lower guide is attached to the underside surface and axially aligned with the through-hole of the susceptor, wherein the lower guide has a central opening through which the lower part of the lift pin is inserted and is axially movable. The central opening has a diameter smaller than that of the middle part of the lift pin. A lower end of the middle part is supported by the lower guide at the opening at the lower position.

In the above, any of the foregoing embodiments of the lift pin structures can be applied.

In any of the foregoing embodiments, the multiple lift pins may have an identical shape and size. Since the lift pin is not attached to the reaction chamber, individual adjustment of each lift pin can be avoided, and identical lift pins can be used. In an embodiment, the susceptor may have three through-holes and three lift pins.

In any of the foregoing embodiments, the upper part of each lift pin may be replaceable by detaching the upper part from the middle part of the lift pin without destruction.

In still another aspect, an embodiment provides a semiconductor processing apparatus comprising: (a) the susceptor of any of the foregoing embodiments; and (b) a reaction chamber surrounding the susceptor and having a supporting surface under the underside surface of the susceptor, wherein when the susceptor moves down, the lower end of the lower part of each lift pin is in contact with the supporting surface and the lift pin is positioned at the upper position, and when the susceptor moves up, the lower end of the lower part of each lift pin is separated from the supporting surface and the lower end of the middle part of the lift pin is supported by the lower guide, and the lift pin is positioned at the lower position. The supporting surface may be integrally formed with walls (more specifically a floor) of the reaction chamber or may be some other component of the reaction chamber. The supporting surface of the illustrated embodiment is fixed with respect to the reaction chamber walls.

In the above, any of the foregoing embodiments of the lift pin structures can be applied. Any of the foregoing lift pin structures can be applied to any suitable semiconductor-processing apparatus using wafer lift pins, including, but not limited to, a thermal CVD apparatus, plasma CVD apparatus, thermal ALD apparatus, and plasma ALD apparatus. Particular advantages may apply to plasma processing apparatus and to environments where purity is of greater importance.

In an embodiment, the lift pin may be made of a material such as ceramics, anodic oxidized aluminum, or a combination of the foregoing. In an embodiment, the upper part may be made of a different material from that of the middle part and the lower part, or the upper part can be coated with an anodic aluminum oxide. In an embodiment, the upper guide may be made of ceramics. Because the middle part of the lift pin slides upon an inner surface of the upper guide, preferably, the material of the middle part of the lift pin and the upper guide are made of different materials so that slidability can be improved. In an example, the upper guide is made of aluminum nitride (AlN), whereas the middle part of the lift pin is made of alumina (Al₂O₃). Further, preferably, the inner surface of the upper guide and the outer surface of the middle part are polished.

In an embodiment, the dimensions of the lift pin may be as follows: The length of the upper part: 15-35 mm; the length of the middle part: 15-100 mm; the length of the lower part: 20-80 mm; the diameter of the upper part: 2-6 mm; the diameter of the middle part: 12-30 mm; the diameter of the lower part: 5-20 mm; the depth of the lower through-hole: 15-100 mm; the depth of the upper through-hole: 5-20 mm; the inner diameter of the lower through-hole: 15-40 mm; the inner diameter of the upper through-hole: 3-10 mm; the length of the upper guide: 15-100 mm; the length of the lower guide: 10-50 mm; the inner diameter of the upper guide: 12-30 mm; the inner diameter of the lower guide: 12-35 mm; the outer diameter of the upper guide: 15-40 mm; the outer diameter of the lower guide: 20-60 mm. The inner diameter of the upper through-hole is slightly larger than the diameter of the upper part but smaller than the diameter of the middle part. The inner diameter of the upper guide is slightly larger than the diameter of the middle part to the extent that the middle part can slide upon the inner surface of the upper guide without undue friction. The outer diameter of the upper guide is the same as the inner diameter of the lower through-hole, so that they can be fixed by press-fit, for example. The inner diameter of the lower guide is slightly larger than the diameter of the lower part but smaller than the diameter of the middle part so that the lower guide can stop the downward movement of the middle part. The length of the upper guide can be shorter than the depth of the lower through-hole.

In an embodiment, the diameter of the upper part of the lift pin (DU), the diameter of the middle part of the lift pin (DM), and the diameter of the lower part of the lift pin (DL) satisfy the following relationship: DU<DL<DM, preferably, 3DU<DM (more preferably, 4DU<DM). By significantly enlarging the diameter of the middle part as compared with the diameter of the upper part, slidability and stability can be improved. For a non-hollow cylindrical shape with a diameter D, the surface area of the cylindrical part per volume (per weight) changes as a function of 4/D. Slidability can be improved as the diameter increases. Further, in an embodiment, the middle part of the lift pin has a sufficient length so that stability of movement can be improved. In an embodiment, the length of the middle part is 25% or more (preferably 30% or more) of the entire length of the lift pin. In the above embodiment, the middle part is sufficiently heavy to smoothly slide down by its own weight of the lift pin by gravity. In an embodiment, the weight of the middle part is 50% or more (preferably 60% or more) of the total weight of the lift pin. In an embodiment, the weight of the upper part is 15% or less (preferably 10% or less) of the total weight of the lift pin. In an embodiment, the lift pin is provided with no additional weight or additional mechanism for stable movement.

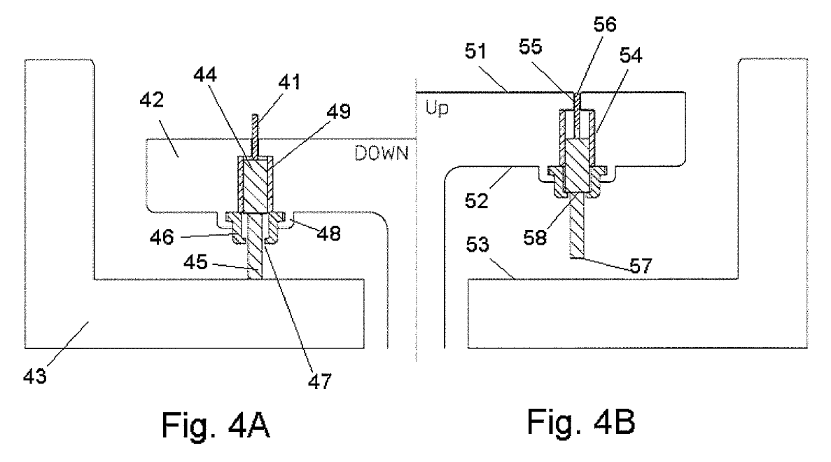

An example will be explained with reference to FIGS. 4A and 4B. The example and the figures are not intended to limit the present invention but illustrate an embodiment. FIGS. 4A and 4B are schematic cross sections showing lift pins and related structures according to an embodiment of the present invention. FIG. 4A shows an upper position of the lift pin (the susceptor is down), whereas FIG. 4B shows a lower position of the lift pin (the susceptor is up).

In this embodiment, the lift pin is constituted by an upper part 41, a middle part 44, and a lower part 45. A susceptor 42 has an upper through-hole 55 for receiving the upper part 41 of the lift pin and a lower through-hole 54 in which an upper guide 49 is fixedly fitted for receiving the middle part 44 of the lift pin. The middle part 44 of the lift pin slides upon an inner surface of the upper guide 49. A lower guide 46 is attached to an underside surface 52 of the susceptor 42 using a ring 48 fixed to the underside surface 52. The ring 48 has cut-outs (not shown) and the lower guide 46 has flanges which are inserted through the cut-outs and secured to the ring 48 with screws (not shown), whereby the lower guide 46 can be fixedly attached to the underside surface 52. The lower guide 46 has a central opening 47 through which the lower part 45 of the lift pin is inserted. A lower end 58 of the middle part 44 of the lift pin is supported by the lower guide 46 at the central opening 47 at the lower position (FIG. 4B). At the lower position, an upper end 56 of the upper part 41 of the lift pin is slightly below an upper surface 51 of the susceptor 42. When the susceptor 42 is lowered, a lower end 57 of the lower part 45 of the lift pin contacts a bottom surface 53 of a reaction chamber 43, and the lift pin can move upward relative to the susceptor 42 (FIG. 4A). At the upper position, the upper end 56 of the upper part 41 of the lift pin protrudes from the upper surface 51 of the susceptor 42. A wafer is supported by the upper end 56 of the upper part 41 of the lift pin.

The structures illustrated in FIGS. 4A and 4B are constituted by five elements: The susceptor 42; the upper part 41 of the lift pin; the middle and lower parts 44, 45 of the lift pin; the lower guide 47; and the upper guide 49. These elements can be assembled as follows:

The upper guide 49 is inserted into the lower through-hole 54 of the susceptor 42 and fixedly fitted inside the lower through-hole 54 by press-fit or crimping (using heat expansion of the susceptor 42 made of a metal such as aluminum), for example. The middle and lower parts 44, 45 of the lift pin are inserted into the upper guide 49 inside the lower through-hole 54 of the susceptor 42. The lower guide 46 is then inserted in the ring 48 and secured to the ring 48 with screws, for example, so as to be fixedly attached to the underside surface 52 of the susceptor 42. The ring 48 is integrally formed (e.g., molded) with the susceptor 42 as a part of the susceptor 42. The upper part 41 of the lift pin is inserted into the upper through-hole 55 from the upper surface 51 of the susceptor 42, and attached to the middle part 44 of the lift pin (e.g. by threads or press-fit).

The position of the upper end 56 of the upper part 41 of the lift pin can be determined when the lower end 57 of the lower part 45 of the lift pin is in contact with and stopped by the bottom surface 53 of the reaction chamber 43 at the pin upper position (when the susceptor 42 is down; FIG. 4A). The position of the upper end 56 of the upper part 41 of the lift pin can be determined when the lower end 58 of the middle part 44 of the lift pin is in contact with and stopped by the lower guide 46 at the pin lower position (when the susceptor 42 is up; FIG. 4B).

In the present disclosure where conditions and/or structures are not specified, the skilled artisan in the art can readily provide such conditions and/or structures, in view of the present disclosure, as a matter of routine experimentation.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A wafer lift pin structure for lifting a semiconductor wafer, comprising:
a through-hole penetrating vertically through a susceptor from an underside surface of the susceptor to an upper surface of the susceptor, wherein the through-hole is constituted by an upper through-hole and a lower through-hole which has an inner diameter larger than an inner diameter of the upper through-hole;
an upper guide having a through-hole in its axial direction aligned with an axis of the through-hole of the susceptor, the upper guide being fixedly fitted in the lower through-hole;
a lift pin constituted by an upper part, a middle part, and a lower part, all of which have a common vertical axis aligned with the axis of the through-hole of the susceptor, wherein the middle part has a diameter larger than that of the upper part, that of the lower part, and an inner diameter of the upper through-hole of the susceptor which is larger than the diameter of the upper part, and the middle part has a weight heavier than that of the upper part and that of the lower part, wherein at least a portion of the middle part is slidably inserted inside the through-hole of the upper guide and axially movable between a lower position and an upper position, wherein an upper end of the upper part for supporting a wafer thereon is below the upper surface of the susceptor at the lower position, and the upper end of the upper part protrudes from the upper surface of the susceptor at the upper position; and
a lower guide attached to the underside surface and axially aligned with the through-hole of the susceptor, wherein the lower guide has a central opening through which the lower part of the lift pin is inserted and axially movable, the central opening having an diameter smaller than that of the middle part of the lift pin, wherein a lower end of the middle part is supported by the lower guide at the opening at the lower position.

2. The wafer lift pin structure according to claim 1, wherein the upper guide and the middle part of the lift pin are made of different ceramics.

3. The wafer lift pin structure according to claim 1, wherein the diameter of the middle part is at least three times the diameter of the upper part of the lift pin.

4. The wafer lift pin structure according to claim 1, wherein the length of the middle part is at least 25% of the entire length of the lift pin.

5. The wafer lift pin structure according to claim 1, wherein the upper part of the lift pin including the upper end thereof has a circular cross section and has a diameter smaller than that of the lower part of the lift pin.

6. The wafer lift pin structure according to claim 1, wherein the upper part of the lift pin is not in contact with the upper surface of the susceptor at the lower position.

7. The wafer lift pin structure according to claim 1, wherein the lower guide is hollow and cylindrical, has a bottom having the central opening, and has an annular rim attached to the underside surface of the susceptor.

8. The wafer lift pin structure according to claim 1, wherein the lower through-hole has a depth greater than a length of the middle part of the lift pin.

9. The wafer lift pin structure according to claim 1, wherein a lower end of the lower part of the lift pin is in contact with a surface of a reaction chamber at the upper position.

10. The wafer lift pin structure according to claim 1, wherein the lift pin moves down by gravity from the upper position to the lower position.

11. The wafer lift pin structure according to claim 1, wherein the lift pin is suspended by gravity from the lower guide at the middle part of the lift pin at the lower position.

12. The wafer lift pin structure according to claim 1, wherein the middle part of the lift pin and the lower part of the lift pin are constituted by a single piece and are not detachable without destruction, and the upper part of the lift pin is detachable from the middle part of the lift pin without destruction.

13. The wafer lift pin structure according to claim 7, wherein the underside of the susceptor is provided with a ring, and the annular rim of the lower guide has a flange fitted in the ring.

14. The wafer lift pin structure according to claim 13, wherein the ring is integrally formed with the susceptor without seams.

15. The wafer lift pin structure according to claim 1, wherein the middle part of the lift pin has a length greater than the diameter.

16. A susceptor for supporting a semiconductor wafer thereon, comprising:
multiple through-holes, each through-hole penetrating vertically through the susceptor from an underside surface of the susceptor to an upper surface of the susceptor, wherein each through-hole is constituted by an upper through-hole and a lower through-hole which has an inner diameter larger than an inner diameter of the upper through-hole;
upper guides corresponding to the respective through-holes of the susceptor, each upper guide having a through-hole in its axial direction aligned with an axis of the through-hole of the susceptor, the upper guide being fixedly fitted in the lower through-hole;
multiple lift pins corresponding to the respective through-holes, each lift pin constituted by an upper part, a middle part, and a lower part, all of which have a common vertical axis aligned with the axis of the through-hole of the susceptor, wherein the middle part has a diameter larger than that of the upper part, that of the lower part, and an inner diameter of the upper through-hole of the susceptor which is larger than the diameter of the upper part, and the middle part has a weight heavier than that of the upper part and that of the lower part, wherein at least a portion of the middle part is slidably inserted inside the through-hole of the upper guide and axially movable between a lower position and an upper position, wherein an upper end of the upper part for supporting a wafer thereon is below the upper surface of the susceptor at the lower position, and the upper end of the upper part protrudes from the upper surface of the susceptor at the upper position; and
multiple lower guides corresponding to the respective through-holes, each lower guide attached to the underside surface and axially aligned with the through-hole of the susceptor, wherein the lower guide has a central opening through which the lower part of the lift pin is inserted and axially movable, the central opening having an diameter smaller than that of the middle part of the lift pin, wherein a lower end of the middle part is supported by the lower guide at the opening at the lower position.

17. The susceptor according to claim 16, wherein the multiple lift pins have an identical shape and size.

18. The susceptor according to claim 16, wherein the upper part of each lift pin is replaceable by detaching the upper part from the middle part of the lift pin without destruction.

19. A semiconductor processing apparatus comprising:
(i) a susceptor which is vertically movable and comprises:
multiple through-holes, each through-hole penetrating vertically through the susceptor from an underside surface of the susceptor to an upper surface of the susceptor, wherein the through-hole is constituted by an upper through-hole and a lower through-hole which has an inner diameter larger than an inner diameter of the upper through-hole;
multiple upper guides corresponding to the respective through-holes of the susceptor, each upper guide having a through-hole in its axial direction aligned with an axis of the through-hole of the susceptor, the upper guide being fixedly fitted in the lower through-hole;
multiple lift pins corresponding to the respective through-holes, each lift pin constituted by an upper part, a middle part, and a lower part, all of which have a common vertical axis aligned with the axis of the through-hole of the susceptor, wherein the middle part has a diameter larger than that of the upper part, that of the lower part, and an inner diameter of the upper through-hole of the susceptor which is larger than the diameter of the upper part, and the middle part has a weight heavier than that of the upper part and that of the lower part, wherein at least a portion of the middle part is slidably inserted inside the through-hole of the upper guide and axially movable between a lower position and an upper position, wherein an upper end of the upper part for supporting a wafer thereon is below the upper surface of the susceptor at the lower position, and the upper end of the upper part protrudes from the upper surface of the susceptor at the upper position; and
multiple lower guides corresponding to the respective through-holes, each lower guide attached to the underside surface and axially aligned with the through-hole, wherein the lower guide has a central opening through which the lower part of the lift pin is inserted and vertically movable, the central opening having an diameter smaller than that of the middle part of the lift pin, wherein a lower end of the middle part is supported by the lower guide at the opening at the lower position; and
(ii) a reaction chamber surrounding the susceptor and having a supporting surface under the underside surface of the susceptor, wherein when the susceptor moves down, the lower end of the lower part of each lift pin is in contact with the supporting surface and the lift pin is positioned at the upper position, and when the susceptor moves up, the lower end of the lower part of each lift pin is separated from the supporting surface and the lower end of the middle part of the lift pin is supported by the lower guide, and the lift pin is positioned at the lower position.
